(19) United States
(12) Patent Application Publication
(10) Pub. No.: US 2008/0310465 A1
(43) Pub. Date: Dec. 18, 2008

(54) Method and Laser Device for Stabilized Frequency Doubling

(76) Inventor: Martin Achtenhagen, Plano, TX (US)

Correspondence Address: SLATER & MATSIL, L.L.P., 17950 PRESTON RD, SUITE 1000, DALLAS, TX, 75252-5793, US

(21) Appl. No.: 11/763,248

(22) Filed: Jun. 14, 2007

(51) Int. Cl. H01S 3/109

(52) U.S. Cl. 372/22

(57) ABSTRACT

A system and method for emitting a plurality of second harmonic light frequencies that is generally unaffected by small variations in external cavity length and temperature. An illustrative embodiment provides a laser system that comprises a semiconductor gain region operating within the coherence collapse regime, an intra-cavity nonlinear optical medium, and a feedback reflector. The semiconductor gain region operates in the coherence collapse regime and produces broad frequency fundamental light, the nonlinear resonator doubles a first portion of the broad frequency fundamental light and emits a plurality of second harmonic light frequencies external to the laser system. A second portion of the broad frequency fundamental light is reflected into the semiconductor gain region with a feedback power ratio sufficient to cause the semiconductor gain region to operate in the coherence collapse regime.

### TECHNICAL FIELD

The present invention relates generally to semiconductor laser systems and methods, and more particularly to a method and a laser system for stabilized frequency doubling.

### BACKGROUND

A laser is an optical source that emits photons in a coherent beam. Laser light is typically a single wavelength or color, and emitted in a narrow beam. Laser action is explained by the theories of quantum mechanics and thermodynamics. Many materials have been found to have the required characteristics to form the laser gain medium needed to power a laser, and these have led to the invention of many types of lasers with different characteristics suitable for different applications.

A semiconductor laser is a laser in which the active medium is a semiconductor. A common type of semiconductor laser is formed from a p-n junction, a region where p-type and n-type semiconductors meet, and powered by injected electrical current. As in other lasers, the gain region of the semiconductor laser is surrounded by an optical cavity. An optical cavity is an arrangement of mirrors, or reflectors that form a standing wave resonator for light waves.

Optical resonators are often called cavities, and the terms are often used interchangeably in optics. Use of the term cavity does not imply a vacuum or air space. A cavity as used in optics may be within a solid crystal. An optical cavity (or optical resonator) is an arrangement of optical components, which allows a beam of light to circulate. In a simple form of semiconductor laser; for example a laser diode, an optical cavity may be formed in epitaxial layers, such that the light is confined to a relatively narrow area perpendicular (and parallel) to the direction of light propagation. There are two basic types of cavities: standing-wave or linear cavities, where the light bounces back and forth between two end reflectors; and ring cavities, where the light may make round trips in two different directions.

The color or frequency of the emitted light may depend on the gain medium. Another method is called frequency doubling. In this method, a fundamental laser frequency is introduced into a nonlinear medium, and a portion of the fundamental frequency is doubled. Frequency doubling in nonlinear material, also called second harmonic generation (SHG), is a nonlinear optical process, in which photons interacting with a nonlinear material are effectively “combined” to form new photons with twice the energy and, therefore, twice the frequency and half the wavelength of the initial photons.

Typically, lasers are developed and tuned to emit a narrow frequency of light with a portion of the laser light fed back into the gain region. Many observations and calculations of the effects that can occur in semiconductor lasers subjected to reflections external to the gain region have been made. Principally, five regimes of feedback effects in lasers have been defined.

The regimes are defined by the behavior of the frequency spectra of the laser subjected to different feedback power level ratios. Generally, these five regimes of operation are experimentally well defined, and the transitions between them may be easily identified. For example, refer to R. W. Tkach et al., “Regimes of Feedback Effects in 1.5-μm Distributed Feedback Lasers,” Journal of Lightwave Technology, vol. LT-4 (11), pp. 1655-1661, November, 1986.

Regime I, the lowest level of feedback, shows a narrowing or broadening of the frequency emission line, depending on the phase of the feedback. The phase of the feedback is critical in Regime I. Any slight change in phase causes emission linewidth instability. Regime II shows instabilities in emission linewidth, depending on the distance to the external reflector. The broadening, which is observed at the lowest levels for out of phase feedback, changes to an apparent splitting of the emission line, arising from rapid mode hopping. The magnitude of the splitting depends on the strength of the feedback and on the distance to the reflector.

Regime III is entered as the feedback is increased further. The emission linewidth in Regime III does not depend on the distance to the reflection; the mode hopping is suppressed, and the laser is observed to operate on a single narrow line. This regime may occupy only a small range of feedback power ratio; for example, from −45 dB to −39 dB, and, consequently, the laser remains sensitive to other reflections of comparable or greater magnitude.

Regime IV is at a feedback level that does not depend on the distance to the reflection and may occur for a distributed feedback laser; for example from −38 dB to −8 dB. The transition from Regime III to Regime IV may occur at higher feedback power ratios for higher laser powers. Referring to FIG. 1, Regime IV is defined by satellite modes 100 appearing separated from the main mode by the relaxation oscillation frequency. These satellite modes 120 grow as the feedback power ratio increases, and the laser emission line 140 may broaden to as much as 50 GHz with further feedback power. The transition between Regime IV and Regime V may occur at a lower feedback power ratio (lower than −8 dB) for higher laser power. Regime IV is termed “coherence collapse” because of the drastic reduction in the coherence length of the laser. Coherence length is the propagation distance from a coherent source to a point where an electromagnetic wave maintains a specified degree of coherence. Degree of coherence is the parameter that quantifies the quality of the interference. The effects within this regime are independent of the feedback phase. Due to the emission line broadening properties and smaller coherence length, lasers that operate in Regime IV are historically avoided or relegated to pump lasers. The transition between Regime IV and Regime V is at the feedback power ratio at which the emission line narrows.

Regime V is defined at the highest levels of feedback (typically greater than −10 dB) with a narrow linewidth emission observed. Typically, it is necessary to use an antireflection coat on the laser facet to reach this regime. In this regime, the laser operates as a long cavity laser with a short active region. If there is sufficient frequency selectivity in the cavity, the laser operates on a single longitudinal mode with narrow linewidth emission for all phases of the feedback. In regime V, the laser is relatively insensitive to additional external optical perturbations.

An anti-reflection coating may be needed in order to achieve a higher power ratio feedback. An anti-reflection coating (AR coating) is a dielectric coating applied to an optical surface in order to reduce the optical reflectivity of that surface in a certain wavelength range. In most cases, the basic operation principle is to introduce one or more additional optical interfaces so that the reflected waves from all the different interfaces largely cancel each other by destructive interference.

One disadvantage of the prior art is that stability of the laser may be dependent upon the cavity configuration. Any slight variation in distance or temperature may cause an erratic laser output. Another disadvantage of the prior art is in frequency doubling, also termed second harmonic generation (SHG), a single frequency emission system may be an advantage for communication signals but not an advantage for illumination uses or display systems.

### SUMMARY OF THE INVENTION

These and other problems are generally solved or circumvented, and technical advantages are generally achieved, by preferred embodiments of the present invention, which may emit a plurality of stable second harmonic light in closely related frequencies, which are generally unaffected by small variations in external cavity length and temperature.

Illustrative embodiments provide a semiconductor laser system that comprises a semiconductor gain region operating within the coherence collapse regime, an intra-cavity nonlinear optical medium, and a feedback reflector. The intra-cavity laser system comprises a semiconductor gain region operating in the coherence collapse regime and producing broad frequency fundamental light, a nonlinear resonator optically coupled to the semiconductor gain region, and a coherence collapse reflector optically coupled to the nonlinear resonator and to the semiconductor gain region. The nonlinear resonator doubles a first portion of the broad frequency fundamental light and emits a plurality of second harmonic light frequencies external to the laser system. A second portion of the broad frequency fundamental light is reflected into the semiconductor gain region with a feedback power ratio sufficient to cause the semiconductor gain region to operate in the coherence collapse regime.

Illustrative embodiments further include a method of generating a plurality of second harmonic light frequencies in an intra-cavity laser. The method comprises operating a laser gain region in coherence collapse and producing broad frequency fundamental light in the laser gain region. A first portion of the broad frequency fundamental light is fed back into the laser gain region; this forces the laser gain region into coherence collapse. Further, a second portion of the broad frequency fundamental light is doubled to form a plurality of second harmonic light frequencies. The plurality of second harmonic light frequencies is emitted from the intra-cavity laser.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows three known laser spectra at different feedback power ratios illustrating spectral signatures of a laser in coherence collapse.

FIG. 2 is a block diagram of a stabilized frequency doubling laser cavity operated in the coherence collapse regime.

FIG. 3 depicts graphs of the spectra for each light path depicted in the block diagram of FIG. 2.

FIG. 4 shows an embodiment of a stabilized frequency doubling laser cavity operated in the coherence collapse regime.

FIG. 5 shows another embodiment of a stabilized frequency doubling laser cavity operated in the coherence collapse regime.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely an edge emitting distributed Bragg reflector as the laser gain region with a total internal reflection crystal resonator, and a coherence collapse feedback reflector. Other laser types and configurations may also be applied to the illustrative embodiments.

Optical communication systems, as well as other laser applications, may require a narrow linewidth emission; therefore, lasers have been typically operated in the feedback power ratio of Regime V or Regime III. This enables operation with a narrow linewidth emission. Illustrative embodiments provide a system and a method of operating an extended cavity laser in the feedback power ratio of Regime IV. The broadened frequency emission of the gain region operating in the coherence collapse regime beneficially increases the power and stability of the doubled frequency emission. Operating in the coherence collapse regime, the gain region produces an infrared light across broad frequency emission linewidth (in the range of 50 GHz). Within this broad emission, there may then be a plurality of frequencies that are mode matched to a nonlinear resonator. The nonlinear resonator may act as a frequency doubling resonator. The nonlinear resonator then doubles a portion of each of the accepted modes of the broad frequency fundamental light and emits a plurality of second harmonic frequencies of each of the accepted modes of the fundamental light. In this example, frequencies are blue or green light. A portion of the miss-mode matched infrared light is reflected back into the gain region. An antireflective coating facet on the laser gain region may aid in increasing the amount of feedback power into the laser gain region, thereby allowing a sufficient feedback power ratio to force the gain region into the coherence collapse regime. To those of ordinary skill in the art it is obvious that there are some fractional light losses in these operations and that while not addressed directly, these fractional light losses are within the scope of this invention. The plurality of second harmonic frequency light is emitted from the laser cavity.

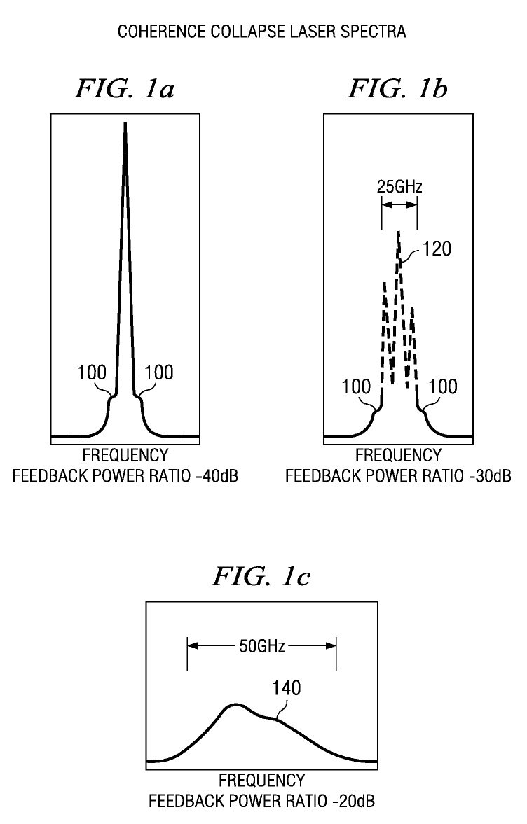

With reference now to FIGS. 1a-1c, three known laser spectra at different feedback power ratios illustrating spectral signatures of a laser in coherence collapse are shown. These example laser spectra were taken by Tkach and Chraplevy with a 125-GHZ free spectral range Fabry-Perot interferometer with differing feedback power ratios illustrating various stages of the coherence collapse regime of laser operation.

FIG. 1a shows a laser spectrum with a feedback power ratio of essentially −40 dB. Relaxation oscillation side-bands 100 first appear in this spectrum. FIG. 1b illustrates a laser spectrum with an increased feedback power ratio of essentially −30 dB, and shows the relaxation oscillation side-bands 100 and a degeneration of the narrow frequency band into multiple frequency bands 120. FIG. 1c shows a spectrum at an increased feedback power ratio of −20 dB. At −20 dB, the spectrum shows a widened smoother spectrum 140. The frequency range of spectrum 140 may be on the order of 10-60 GHz. Therefore, the coherence collapse regime is unsuitable for many applications. However, the comparatively broad frequency band of the coherence collapse regime, with the relative insensitivity to external cavity instability of the coherence collapse regime is used advantageously by illustrative embodiments of the present invention.

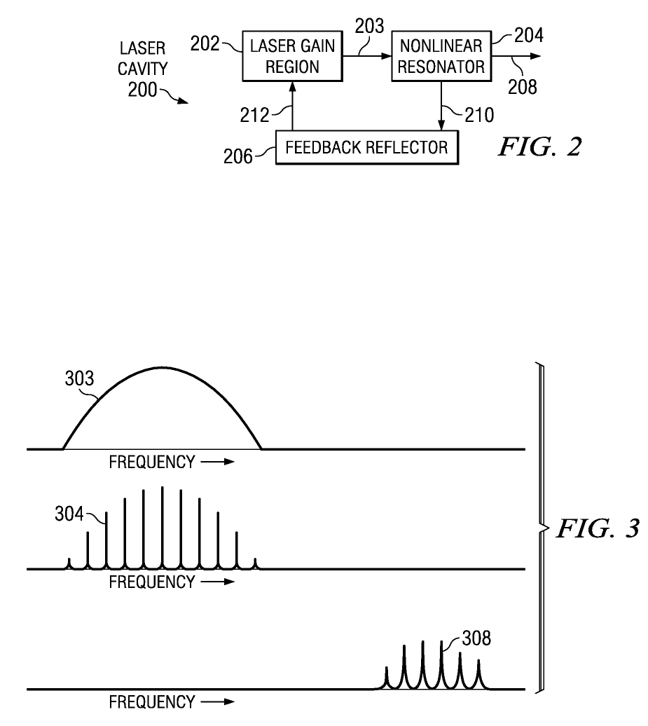

FIG. 2 shows a block diagram of a second harmonic generation intra-cavity laser system in accordance with the illustrative embodiments of the present invention. The intra-cavity laser system is comprised of a laser gain region 202, a nonlinear resonator 204, and a feedback reflector 206. The components of the intra-cavity laser system are optically coupled. Fundamental path 203 is the optical path between the laser gain region 202 and the nonlinear resonator 204. Emitting light path 208 is the path on which the secondary light is emitted external to the laser system. Reflecting path 210 is the path in which fundamental light that has not been doubled to secondary (second harmonic) light is reflected to feedback reflector 206. Feedback path 212 is the light path for the Regime IV feedback light. Any or all of these paths may have additional optical components within them. Further, any or all of these paths may physically be one or more paths. The light paths may also physically overlap, with light traveling in the same or opposite directions. Further detail on the laser spectra associated with each path follows in the description of FIG. 3.

The laser gain region 202 may be an edge emitting laser, a grating outcoupled surface emitting (GSE) laser, or a vertical cavity surface emitting (VCSEL) laser. Laser gain region 202 may be configured with, for example, a distributed Bragg reflector; a lateral distributed Bragg reflector; or a Fabry-Perot resonator, among other configurations. Laser gain region 202 may be a distributed feedback laser.

Nonlinear resonator 204 may include a nonlinear crystal, such as KNbO₃ or Cr³⁺:LiSrAlF₆ (Cr:liSAF). Those of ordinary skill in the art are aware of many nonlinear materials for use in a nonlinear resonator. All of these materials are within the scope of this invention. Nonlinear crystal resonator 204 may comprise mirror components as well as a nonlinear crystal. The mirrors may be a part of nonlinear crystal resonator 204 in which successive passes of the fundamental frequency beam, in this example an infrared beam, reinforce each other so that the infrared intensity circulating inside the resonator becomes many times higher than the intensity incident upon the resonator. Nonlinear crystal resonator 204 may be, for example, a standing wave resonator or a bow-tie type ring resonator, as well as other types of nonlinear resonators known to those of ordinary skill in the art. Nonlinear crystal resonator 204 may alternately be of a total internal reflection configuration, without reflectors or mirrors external to the nonlinear crystal.

A coherence collapse feedback reflector 206 may be a single reflector or a system of reflectors that may reflect sufficient power into the laser gain region to force the laser into coherence collapse. Feedback reflector 206 reflects light with a feedback power ratio in the coherence collapse regime, back into the laser gain region 202 of laser cavity 100. As discussed in the background section above, the coherence collapse regime feedback range is defined by the distinctive appearance of the laser spectra in the regime. At the lower feedback power ratio, transition to the coherence collapse regime satellite modes, separated from the main mode by the relaxation oscillation frequency, occurs. As the feedback power ratio is increased within the coherence collapse regime, the laser spectrum is broadened. As the feedback power ratio is increased further than the coherence collapse regime, into Regime V, the spectrum narrows. For a distributed feedback laser, the coherence collapse regime is from about −38 dB to −8 dB. Different laser configurations may perform in the coherence collapse regime with a feedback power ratio in a different range.

FIG. 3 depicts a spectrum for three light paths depicted in the block diagram of FIG. 2. Spectrum 303 of a light path, such as light path 203 in FIG. 2, exemplifies the relatively broad range of infrared frequencies output from the laser gain region. Spectrum 304 shows the spectrum of fundamental light within the nonlinear resonator. Spectrum 304 indicates the resonant frequency modes “allowed” into the nonlinear resonator. Spectrum 308, of a light path, such as light path 208 in FIG. 2, shows the plurality of blue or green frequencies that may be emitted for a laser cavity, such as laser cavity 200 of FIG. 2. Note that spectrum 308 depicts a relatively broad spectrum of narrow resonant blue or green light frequencies. Generally, this is because only resonant frequency modes of the fundamental light are doubled in the nonlinear resonator. Only the frequencies depicted in spectrum 304 will be doubled. In other words, a plurality of resonant frequencies of, for example, blue or green light may be emitted from laser cavity 200. Green light is in about the 510 to 570 nanometer spectral range. Blue light is in about the 400 to 500 nanometer spectral range.

The spectrum of light path 210 and 212 (not shown) may be the frequencies not in resonance with the nonlinear resonator and other reflected light.

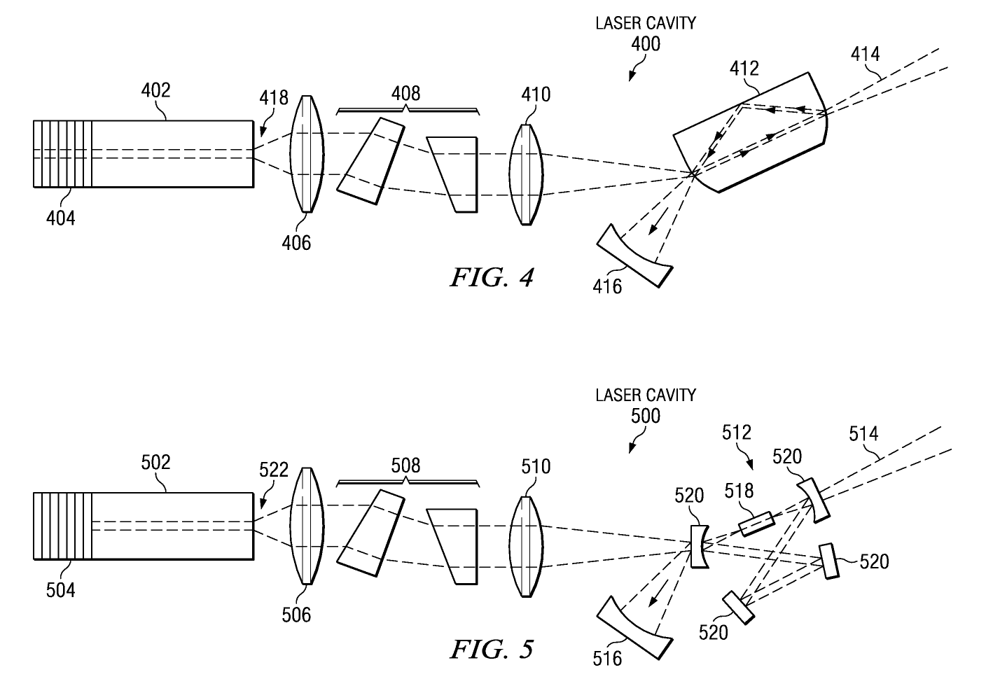

FIG. 4 shows an illustrative embodiment of a stabilized frequency doubling laser cavity operated in the coherence collapse regime in accordance with the illustrative embodiments of the present invention. Laser cavity 400 is an intra-cavity laser configuration with an IR gain region 402, a nonlinear crystal 412, and IR reflector 416 as shown in the stabilized frequency doubling laser cavity of FIG. 2. Laser cavity 400 is shown in this embodiment as an edge emitting laser acting as gain region 402, with a lateral distributed Bragg reflector 404. The IR light emitted from the gain region 402 may be conditioned before reaching nonlinear crystal resonator 412. This conditioning may be achieved, for example, by a collimating lens 406, beam conditioning lenses 408, a mode matching lens 410, as well as other beam conditioning techniques.

While the gain region of the IR laser is shown in this embodiment as edge emitting laser 402 with a lateral distributed Bragg reflector 404, many other embodiments are possible. For example, the gain region of the IR laser may be a surface emitting laser VSCEL or a grating outcoupled surface emitting laser (GSE), or a distributed feedback laser, among other types of semiconductor lasers. Laser cavity 400 may also have phase tuning and frequency tuning capabilities.

Nonlinear crystal 412 is a frequency doubling crystal, such as frequency doubling crystal resonator 204 in FIG. 2. The type of nonlinear resonator shown in this embodiment is a monolithic ring resonator configuration with three reflections, two from surfaces having mirror coatings and one from total internal reflection (TIR). Another type of monolithic ring resonator configuration with three reflections may have one reflection from a mirror-coated surface and two from TIR. Yet another type of monolithic ring resonator configuration has four reflections, all from TIR. Generally, frequency doubling may be carried out by placing a special crystal in a laser beam under a selected angle. Commonly used crystals are BBO (β-barium borate), KDP (potassium dihydrogen phosphate), KTP (potassium titanyl phosphate), and lithium niobate. These crystals have the properties of being strongly birefringent, having a specific crystal symmetry and being transparent for and resistant against the high-intensity laser light. Birefringence, or double refraction, is the decomposition of a ray of light into two rays when it passes through certain types of anisotropic material. Those of ordinary skill in the art will recognize that alternative materials, including organic polymeric materials, may be used for frequency doubling. Generally, only IR beams of a matching mode will enter the nonlinear crystal and have a fraction of the frequencies doubled. The remaining modes may be reflected back into laser gain region 402.

Infrared reflector 416 reflects infrared frequencies back into laser gain region 402. The reflected IR light follows the same light path back into the IR gain region, providing a sufficient feedback power ratio to cause the IR gain region to function in the coherence collapse regime.

Further, an anti-reflective coating 418 may coat the emitting edge of gain region 402. The coating permits the returning reflected IR beam to enter the IR gain region with negligible reflection.

FIG. 5 shows another illustrative embodiment of a stabilized frequency doubling laser cavity operated in the coherence collapse regime in accordance with the illustrative embodiments of the present invention. Laser cavity 500 is an intra-cavity laser configuration with an IR gain region 502, a nonlinear crystal 512, and IR reflector 516 as shown in the stabilized frequency doubling laser cavity of FIG. 2. Laser cavity 500 is shown in this embodiment as an edge emitting laser acting as gain region 502, with a distributed Bragg reflector 504. The IR light emitted from the gain region 502 may be conditioned before reaching nonlinear crystal resonator 512. This conditioning may be achieved, for example, by a collimating lens 506, beam conditioning lenses 508, a mode matching lens 510, as well as other beam conditioning techniques.

While the gain region of the IR laser is shown in this embodiment as edge emitting laser 502 with a distributed Bragg reflector 504, again many other embodiments are possible. For example, the gain region of the IR laser may be a surface emitting laser VSCEL or a grating outcoupled surface emitting laser (GSE), or a distributed feedback laser, among other types of semiconductor lasers. Laser cavity 500 may also have phase tuning and frequency tuning capabilities.

Nonlinear crystal 518 is a frequency doubling crystal, such as frequency doubling crystal resonator 204 in FIG. 2. The type of nonlinear resonator shown in this embodiment is of a discrete configuration termed a bow-tie resonator. Rather than a monolithic ring resonator configuration using total internal reflection (TIR), the discrete configuration frequency doubling resonator uses mirrors 520 for reflection that are discrete from the doubling crystal. Another type of discrete ring resonator configuration may be a standing wave resonator or a three reflection ring resonator. The frequency doubling may be carried out by placing nonlinear crystal 518 in a laser beam under a selected angle. Generally, only infrared beams of a matching mode will enter the nonlinear crystal and have a fraction of the frequencies doubled. The remaining modes may be reflected back into laser gain region 502.

Infrared reflector 516 reflects infrared frequencies back into laser gain region 502. The reflected IR light follows the same light path back into the infrared gain region, providing a sufficient feedback power ratio to cause the infrared gain region to function in the coherence collapse regime.

Further, an anti-reflective coating 522 may coat the emitting edge of gain region 502. The coating permits the returning reflected IR beam to enter the IR gain region with negligible reflection.

Although the present invention and its advantages have been described in detail, it should be understood that various changes, substitutions, and alterations can be made herein without departing from the spirit and scope of the invention as defined by the appended claims. For example, many of the features and functions discussed above can be implemented in alternative components. As another example, it will be readily understood by those skilled in the art that the nonlinear crystal resonator may be varied by type and configuration while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of generating a plurality of second harmonic light frequencies in an intra-cavity laser comprising:
operating a laser gain region in coherence collapse;
producing a broad frequency fundamental light in the laser gain region;
feeding back a first portion of the broad frequency fundamental light into the laser gain region;
doubling a second portion of the broad frequency fundamental light to form a plurality of second harmonic light frequencies; and
emitting from the intra-cavity laser the plurality of second harmonic light frequencies.

2. The method of claim 1, wherein the broad frequency fundamental light is in an infrared frequency range.

3. The method of claim 1, wherein the plurality of second harmonic light frequencies are within a visible frequency range.

4. The method of claim 1, wherein the plurality of second harmonic light frequencies are within a green frequency range.

5. The method of claim 1, wherein the first portion of the broad frequency fundamental light has a feedback power ratio between about −45 db and about −5 db.

6. The method of claim 1, wherein the laser gain region is a semiconductor laser selected from the group consisting of an edge emitting laser, a grating outcoupled surface emitting (GSE) laser, and a vertical cavity surface emitting (VCSEL) laser.

7. The method of claim 1, wherein doubling a second portion of the broad frequency fundamental light to form a plurality of second harmonic light frequencies is accomplished in a nonlinear optical medium.

8. The method of claim 7, wherein the nonlinear optical medium is a nonlinear crystal resonator.

9. An intra-cavity laser system comprising:
a semiconductor gain region operating in the coherence collapse regime and producing a broad frequency fundamental light;
a nonlinear resonator optically coupled to the semiconductor gain region, wherein the nonlinear resonator doubles a first portion of the broad frequency fundamental light and emits a plurality of second harmonic light frequencies external to the intra-cavity laser system; and
a coherence collapse reflector optically coupled to the nonlinear resonator and to the semiconductor gain region, wherein a second portion of the broad frequency fundamental light is reflected into the semiconductor gain region with a feedback power ratio sufficient to cause the semiconductor gain region to operate in the coherence collapse regime.

10. The intra-cavity laser system of claim 9, further comprising:
an anti-reflective coating on an emitting surface of the semiconductor gain region.

11. The intra-cavity laser system of claim 9, wherein the plurality of second harmonic light frequencies are within a visable frequency range.

12. The intra-cavity laser system of claim 9, wherein the plurality of second harmonic light frequencies are within a green frequency range.

13. The intra-cavity laser system of claim 9, wherein the feedback power ratio causing the semiconductor gain region to operate in the coherence collapse regime is between about −40 db and about −5 db.

14. The intra-cavity laser system of claim 9, wherein the semiconductor gain region is selected from the group consisting of an edge emitting laser, a grating outcoupled surface emitting (GSE) laser, and a vertical cavity surface emitting (VCSEL) laser.

15. The intra-cavity laser system of claim 9, wherein the nonlinear resonator is a monolithic ring resonator.

16. The intra-cavity laser system of claim 9, wherein the nonlinear resonator comprises a nonlinear crystal and a set of discrete reflectors.

17. The intra-cavity laser system of claim 9 wherein the nonlinear resonator is selected from the group consisting of a standing wave resonator, a triangle ring resonator, and a bow-tie ring resonator.

18. A method of operating a laser system for generating a plurality of third harmonic light frequencies in an intra-cavity laser comprising:
operating a laser gain region in coherence collapse;
producing a broad frequency fundamental light in the laser gain region;
feeding back a first portion of the broad frequency fundamental light into the laser gain region;
tripling a second portion of the broad frequency fundamental light to form a plurality of third harmonic light frequencies; and
emitting from the intra-cavity laser the plurality of third harmonic light frequencies.

19. The method of operating an intra-cavity laser system of claim 18, wherein the nonlinear resonator is selected from the group consisting of a standing wave resonator, a triangle ring resonator, and a bow-tie ring resonator.

20. The method of operating an intra-cavity laser system of claim 18, wherein the semiconductor gain region is selected from the group consisting of an edge emitting laser, a grating outcoupled surface emitting (GSE) laser, and a vertical cavity surface emitting (VCSEL) laser.
